(19) United States
(12) Patent Application Publication
(10) Pub. No.: US 2017/0127807 A1
(43) Pub. Date: May 11, 2017

(54) Day-Cab Lounger

(71) Applicants: Brent D Lindberg, Anoka, MN (US); Aubri L. Lindberg, Anoka, MN (US)

(72) Inventors: Brent D Lindberg, Anoka, MN (US); Aubri L. Lindberg, Anoka, MN (US)

(21) Appl. No.: 14/934,816

(22) Filed: Nov. 6, 2015

(51) Int. Cl. A45F 3/22; B60N 2/005; B60N 2/04

(52) U.S. Cl. CPC A45F 3/22; B60N 2/04; B60N 2/005

(57) ABSTRACT

A hammock leisure system for the interior of an automobile/semi-truck. The invention is configured of a piece of fabric with adjustable sleeves, that acts as an in-vehicle automobile hammock by hanging across the interior of a vehicle by both of the opposite doorframes, stopped in place with the use of foam dowels. The invention's function is for an individual to rest and/or sleep while laying on the hammock inside of a vehicle.

### BACKGROUND OF THE INVENTION

1. Field of the Invention

This invention relates to the field of interior vehicle leisure systems. More specifically, the invention comprises a hammock leisure system that allows semi-truck/automobile occupants to lay in a hammock suspended inside their vehicle.

2. Description of Related Art

There are many known hammock leisure devices. Most of these devices are for outdoor use and are suspended by the use of trees or specially designed hammock stands. However, this level of sophistication has not yet been used for the inside of a vehicle. The present invention seeks to provide such a sophisticated hammock leisure system for interior use in vehicles.

### BRIEF SUMMARY OF THE PRESENT INVENTION

The present invention comprises a hammock leisure system for the interior of an automobile/semi-truck. The invention is configured of a piece of fabric that acts as a hammock by hanging across the interior of a vehicle. The hammock is assembled by using the opposite door frames of the vehicle to hold the end of the hammock in place. The invention's function is for an individual to rest and/or sleep while laying on the hammock that is suspended inside a vehicle.

### BRIEF DESCRIPTION OF DRAWINGS

FIG. 1 is a drawing of the invention in its entirety, displaying the invention's size and dimensions, indicated in inches.

FIG. 2 displays the adjustment sleeves located at each end of the hammock, and the dimensions

FIG. 3 displays the foam dowel(s) and the dimensions of the foam dowel, indicated in inches

FIG. 4 displays the invention in its assembled state, located inside of a semi-truck vehicle.

FIG. 5 overhead view

FIG. 6 displays invention folded nearly in half to show sleeve ends and handles

FIG. 7 close-up of adjustment sleeves located on each end

FIG. 8 overhead view of invention in its fully assembled state; with two dowels, one located in a sleeve of choice at each end.

FIG. 9 is a perspective view, showing the invention of the Day-Cab Lounger in its fully assembled state and how it is used as an in-vehicle hammock system.

FIG. 10-14 Please disregard and omit these figures, unable to resolve issues of clarity.

### DETAILED DESCRIPTION OF THE INVENTION

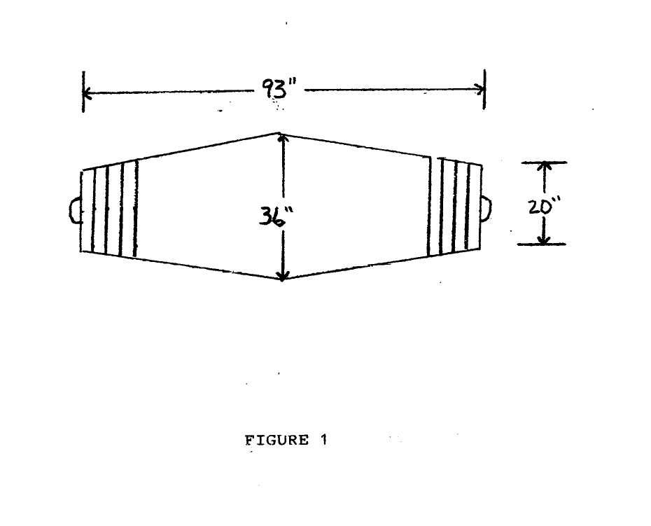

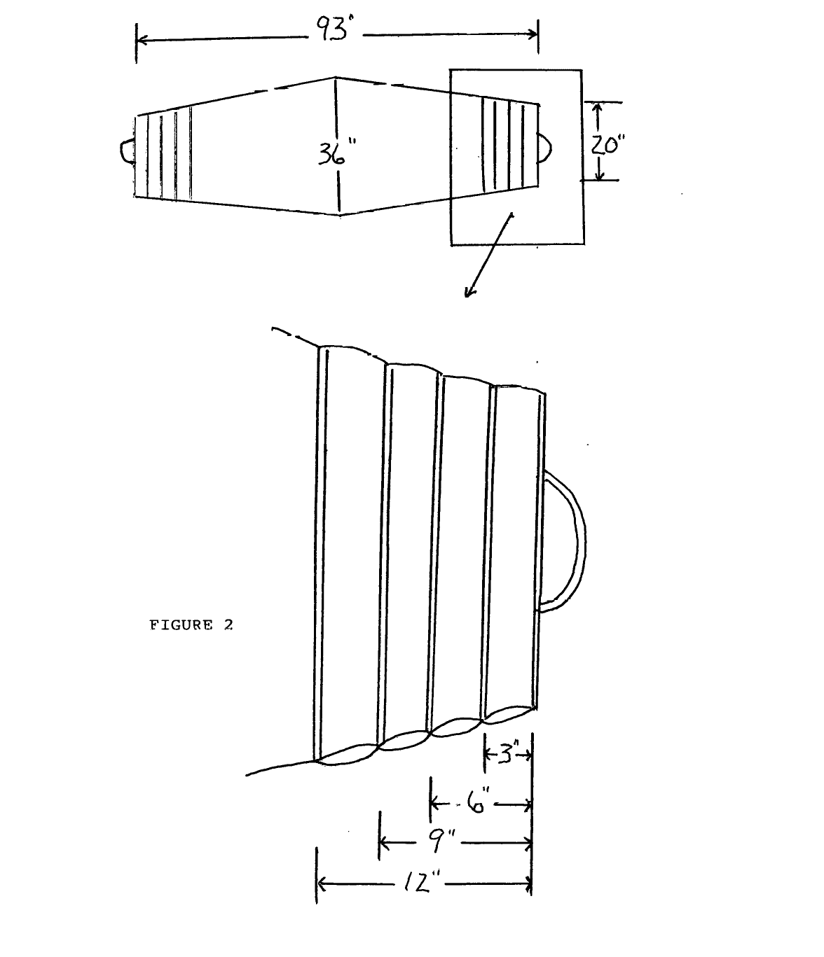

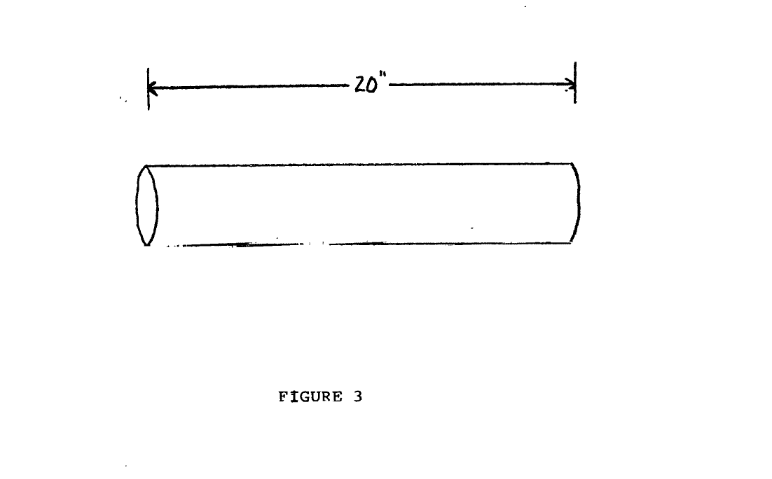

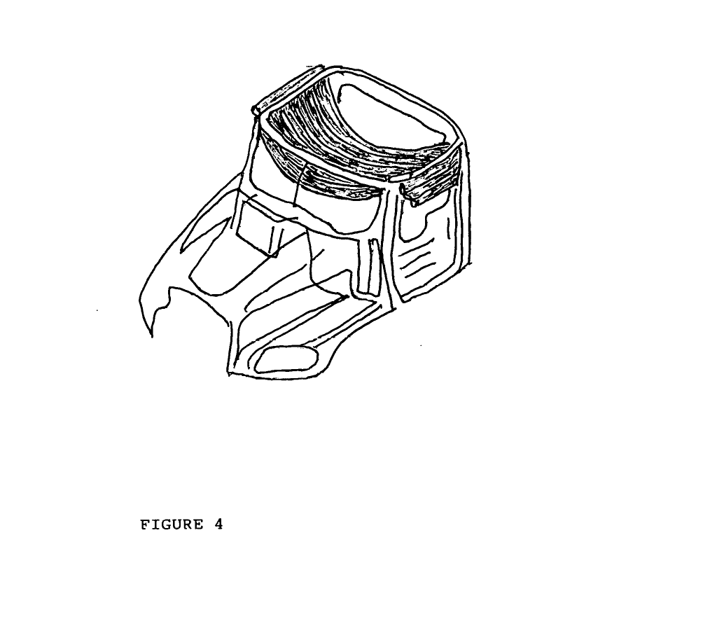

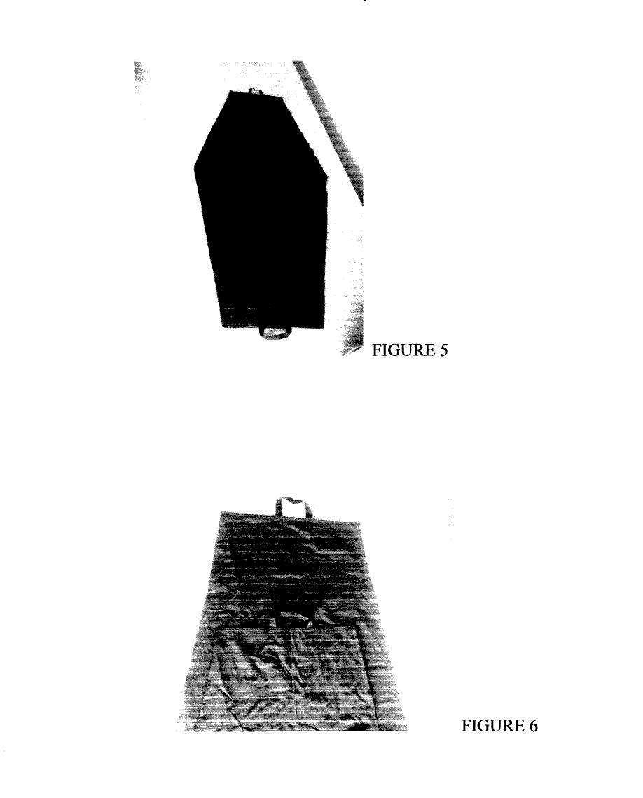

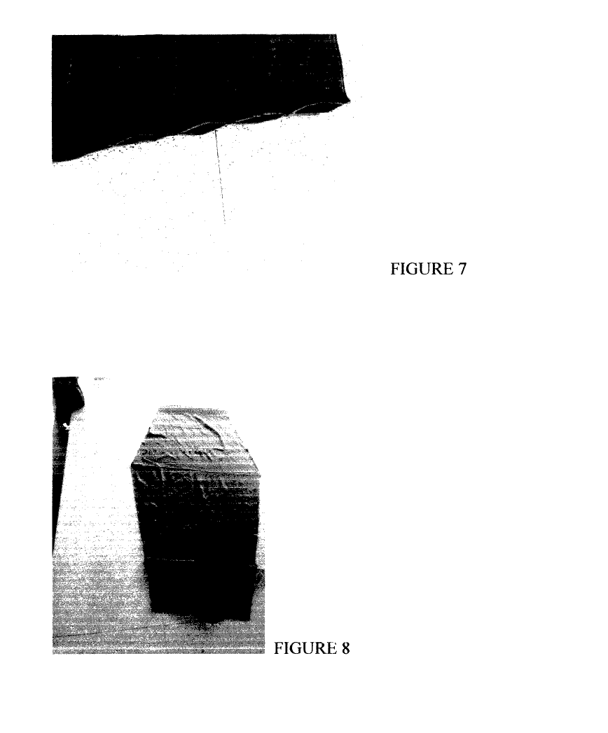

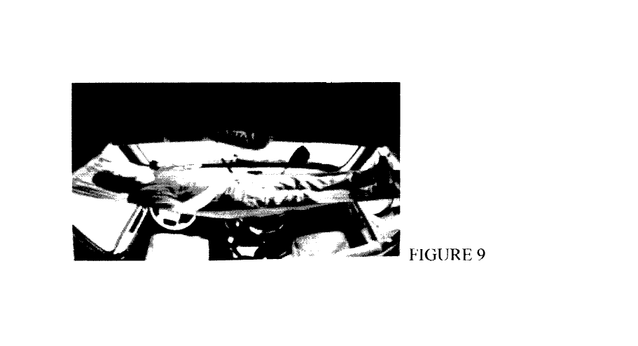

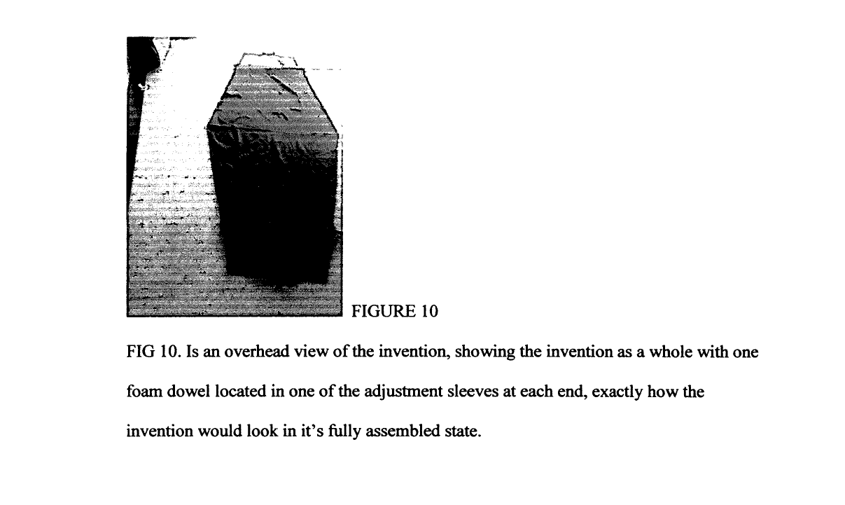

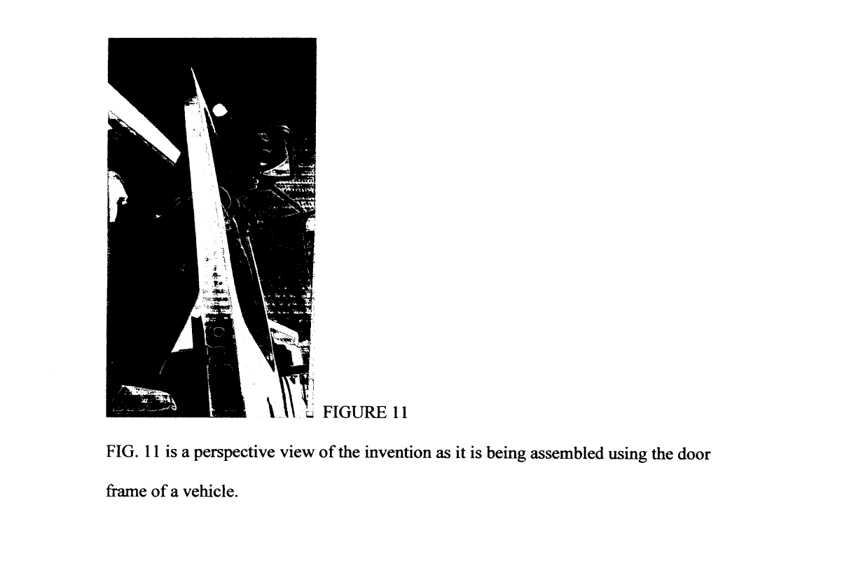

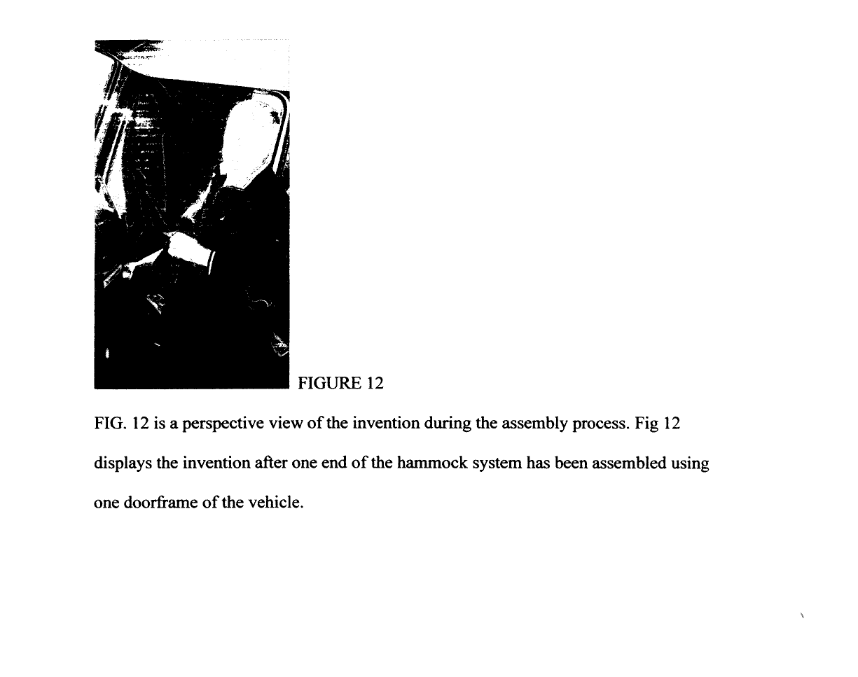

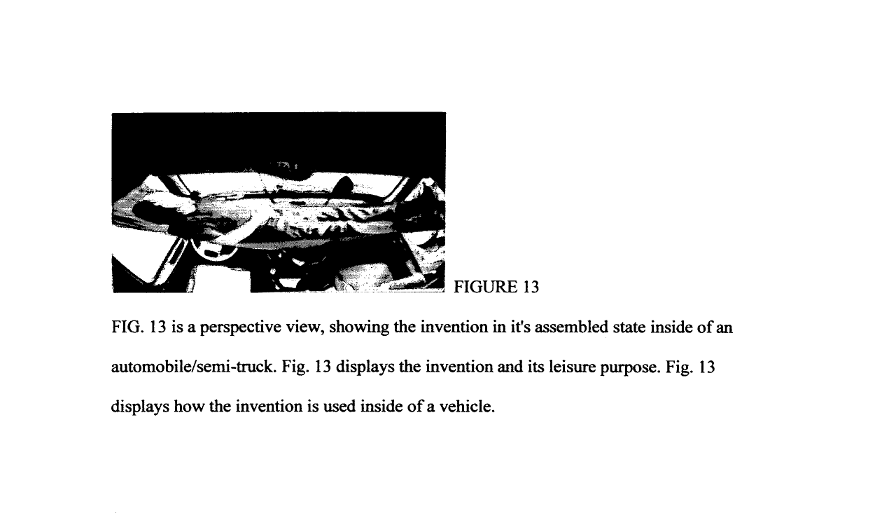

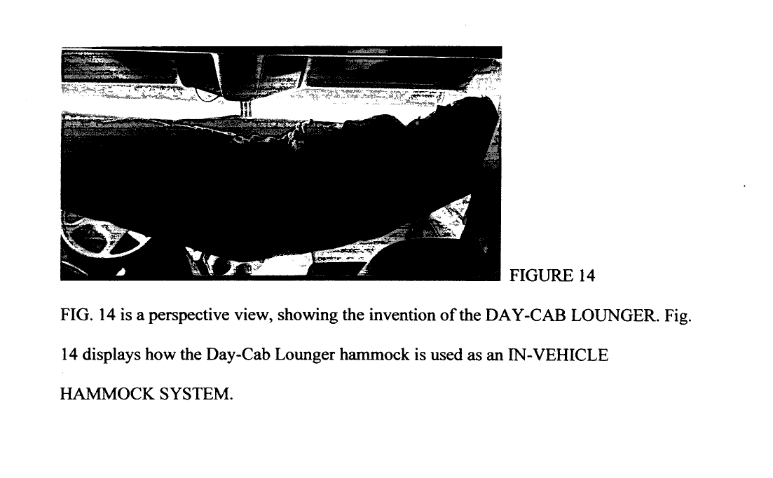

FIG. 9 shows a perspective view of the present invention in an assembled state. Polyester Fabric (shown in FIGS. 1&5) is comprised of four adjustment sleeves on each end (shown in FIG. 2, 7, 8) which are sewn using Nylon Thread (shown in FIGS. 2&7). After the adjustment sleeves have been made, one Foam Dowel (shown in FIGS. 3&8) is inserted in one of the adjustment sleeves on each end of the fabric.

The dowels (shown in FIGS. 3&8) are inserted in the adjustment sleeves on each end of the fabric to act as a framing/end stop on the outside of the door frame as it is draped over the top of the door frame and the door is closed and weight is added to the hammock.

(FIG. 9) Shows how the invention is assembled using the opposite door frames of an automobile/semi-truck. The assembler can assemble the hammock inside of their automobile/semi-truck by opening the door of their vehicle and draping one end of the fabric and the dowel (inserted into one of the adjustment sleeves) over the top of the open door frame. The assembler then closes their door leaving a small portion of the fabric and the dowel hanging outside of their door. The assembler then does the same process with the other end of the fabric using the opposite doorframe of the vehicle. Once hammock is in place, the assembler is encouraged to lock their doors before using.

When these steps are complete, the automobile/semi-truck interior hammock leisure system is ready for use as displayed in (FIG. 9).

Although the preceding description contains significant detail, it should not be construed as limiting the scope of the invention but rather as providing illustrations of the referred embodiments of the invention. Thus, the scope of the invention should be fixed by the following claims rather than any specific examples provided.

Having described my invention, I claim:

1. An automobile/semi-truck in-vehicle hammock system

2. An automobile/semi-truck interior hammock system as recited in claim 1, wherein configuration for attachment is done by the opposite door frames of the vehicle.

3. An automobile/semi-truck interior hammock system as recited in claim 1, comprising of:
a. Polyester fabric
b. Foam dowels
c. Adjustable sleeves

4. An automobile/semi-truck in-vehicle hammock system as recited in claim 1, where in, an individual lays in it for leisure purpose.
